(19) United States
(12) Patent Application Publication
(10) Pub. No.: US 2007/0023147 A1
(43) Pub. Date: Feb. 1, 2007

(54) MACHINE FOR THE MANUFACTURE OF A WEB OF AT LEAST SINGLE-FACED CORRUGATED BOARD

(75) Inventor: Harald Neumann, Parkstein (DE)

Correspondence Address: BARNES & THORNBURG LLP, P.O. BOX 2786, CHICAGO, IL, 60690-2786, US

(73) Assignee: BHS CORRUGATED MASCHINEN- UND ANLAGENBAU GMBH, Weiherhammer (DE)

(21) Appl. No.: 11/459,744

(22) Filed: Jul. 25, 2006

(30) Foreign Application Priority Data
Jul. 27, 2005 (DE) 10-2005-035030.5

(51) Int. Cl. B31F 1/20

(52) U.S. Cl. 156/462

(57) ABSTRACT

A machine for the manufacture of a web of single-faced corrugated board comprises a nip pressure device for a liner web to be pressed against a corrugated paper web. This nip pressure device comprises a nip pressure belt which is comprised of a fabric of metal with warp threads and weft threads. The warp threads and weft threads are connected to each other at least where intersecting.

### BACKGROUND OF THE INVENTION

1. Field of the Invention

The invention relates to a machine for the manufacture of a web of at least single-faced corrugated board, comprising two fluted rollers for producing a corrugation on a paper web; a gluing device for glue to be spread on the tips of the corrugation of the corrugated paper web; a nip pressure device for a liner web to be pressed against the tips, provided with glue, of the corrugated paper web that rests on one of the fluted rollers along a nip pressure area, the nip pressure device comprising a continuous nip pressure belt, which is led along of deflection roller and another roller, and which is forced against the fluted roller along the nip pressure area, and which is comprised of a fabric of metal with warp threads and weft threads.

2. Background Art

A machine of the generic type is known from U.S. Pat. No. 6,092,579. Practice has shown that the quality of the webs of lined corrugated board that are produced leave much to be desired. That is due to the fact that the nip pressure belts become distorted during operation i.e., they regularly constrict.

### SUMMARY OF THE INVENTION

It is an object of the invention to embody a machine of the generic type in such a way that the quality of the produced web of corrugated board will not be affected during the lifetime.

According to the invention, this object is attained by the warp threads and the weft threads, at least where intersecting, being connected to each other by plastic material. A tight connection between weft threads and warp threads has proved to efficiently suppress any distortion of the nip pressure belt during operation so that the quality of the produced web of corrugated board is reliably maintained even for a prolonged lifetime.

The embodiment according to which the warp threads and the weft threads are connected to each other only where they intersect ensures that permeability to vapour of the belt is maintained. That applies in particular in combination with the feature wherein the nip pressure belt is provided with a coating that is disposed on both sides of the weft threads.

As a result of the embodiments according to which the warp threads and the weft threads, by a coating, are connected to each other over their full surface at least on one side of the nip pressure belt, and according to which the coating is located on an outer surface, resting on the liner web, of the nip pressure belt, permeability to vapour of the nip pressure belt is no longer available, however soiling of the nip pressure belt by particles of the paper sheets is precluded.

The measures according to the invention can be used with fabrics in which a coating is disposed on both sides of the weft threads, and in which the warp threads are provided in pairs of three warp threads, the distance of two neighbouring pairs of warp threads being less than the width of each pair of warp threads.

Further advantages, features and details of the invention will become apparent from the ensuing description of exemplary embodiments, taken in conjunction with the drawing.

### BRIEF DESCRIPTION OF THE DRAWING

FIG. 1 is a side view of a familiar machine for the manufacture of a web of single-faced corrugated board;

FIG. 2 is a plan view of details of a three-warp-thread nip pressure belt with warp threads and weft threads being connected spotwise;

FIG. 3 is a cross-sectional view of the nip pressure belt of FIG. 2 as seen on the line III-III of FIG. 2;

FIG. 4 is a longitudinal sectional view of the nip pressure belt of FIG. 2 as seen on the line IV-IV of FIG. 2;

FIG. 5 is a cross-sectional view of a warp thread;

FIG. 6 is a plan view of details of a three-warp-thread nip pressure belt with unilateral full-face coating;

FIG. 7 is a cross-sectional view of the nip pressure belt of FIG. 6 as seen on the line VII-VII of FIG. 6;

FIG. 8 is a longitudinal sectional view of the nip pressure belt of FIG. 6 as seen on the line VIII-VIII of FIG. 6;

FIG. 9 is an illustration, corresponding to FIG. 7, of a cross-sectional view of a bilaterally coated three-warp-thread nip pressure belt;

FIG. 10 is an illustration, corresponding to FIG. 8, of a longitudinal sectional view of the nip pressure belt of FIG. 9;

FIG. 11 is a plan view of details of a tightly woven nip pressure belt with warp threads and wefts threads being connected spotwise;

FIG. 12 is a cross-sectional view of the nip pressure belt of FIG. 11 as seen on the line XII-XII of FIG. 11;

FIG. 13 is a longitudinal sectional view of the nip pressure belt of FIG. 11 as seen on the line XIII-XIII of FIG. 11;

FIG. 14 is a plan view of details of a tightly woven nip pressure belt with unilateral full-face coating;

FIG. 15 is a cross-sectional view of the nip pressure belt of FIG. 14 as seen on the line XV-XV of FIG. 14;

FIG. 16 is a longitudinal sectional view of the nip pressure belt of FIG. 14 as seen on the line XVI-XVI of FIG. 14;

FIG. 17 is an illustration, corresponding to FIG. 15, of a cross-sectional view of a tightly woven, bilaterally coated nip pressure belt;

FIG. 18 is an illustration, corresponding to FIG. 16, of a longitudinal sectional view of the nip pressure belt of FIG. 17.

### DESCRIPTION OF PREFERRED EMBODIMENTS

A machine frame 1 houses a bottom fluted roller 2 and a top fluted roller 3 rotarily by means of shafts 4, 5. They have axes 6, 7 that are parallel to each other. Their cylindrical surfaces are provided with flutings 8, 9 which are parallel to the axes 6, 7, meshing in the contact area 10 of the two fluted rollers 2, 3. One of the fluted rollers 2, 3, customarily the top fluted roller 3, is driven in a direction of rotation 12, whereas the other fluted roller, customarily the bottom fluted roller 2, is entrained by the fluted roller 3 in the direction of rotation 11. A gluing device 13 is disposed in the machine frame 1 downstream of the contact area 10 in the direction of rotation 11 and 12, respectively; it comprises a glue-spreading roller 14 which can be set to the fluting 9 of the top fluted roller 3. The glue-spreading roller 14 is rotatable about an axis 15.

A nip pressure device 16 is provided in the top area of the top fluted roller, comprising a deflection roller 17, a looping roller 18 and a nip pressure belt 19. By means of shaft journals 20 and 21, the deflection roller 17 and the looping roller 18 are mounted freely rotatably about a respective axis 24 and 25 in bearings 22 and 23 of the machine frame 1 i.e., they are not driven. All the axes 6, 7, 15, 24, 25 are parallel to each other. Embodiments of the looping roller 18 are generally known, for example from DE 44 20 726 A (corresponding to U.S. Pat. No. 5,632,850). Tightening the nip pressure belt 19 takes place by displacement of the looping roller 18 in parallel to the delivery tangent 27 in a direction 28.

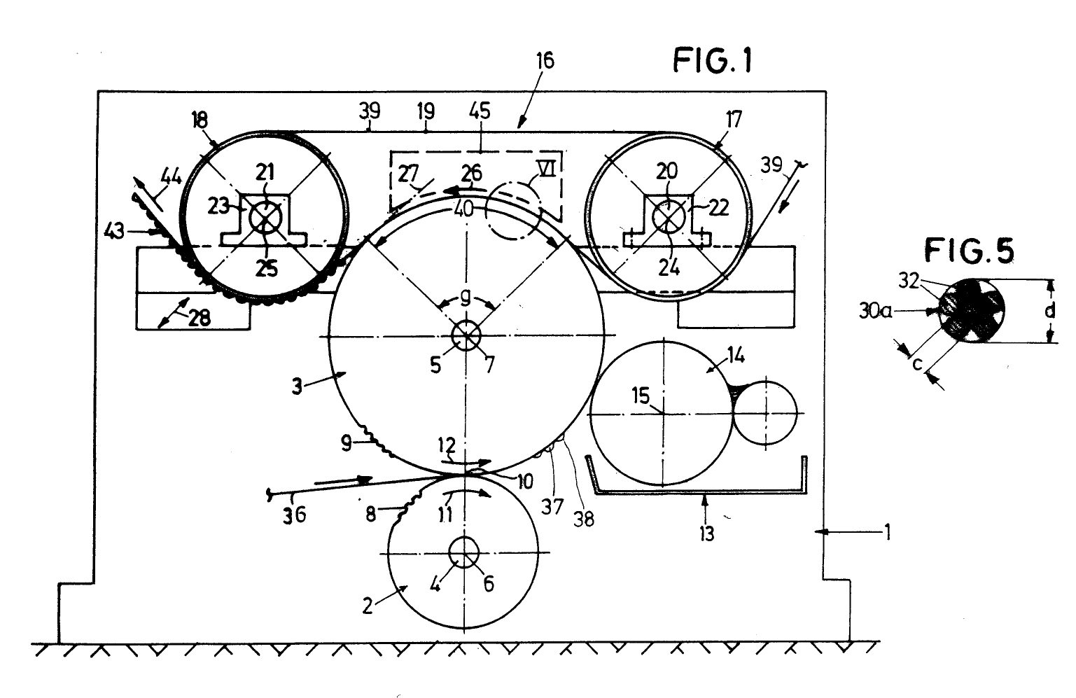

As seen in FIG. 1, the nip pressure belt 19 rests on the fluting 9 of the top fluted roller 3 by an angle of belt contact g of approximately 90°, running along with it in the same direction of rotation in accordance with the arrow 26. The nip pressure belt 19 runs off the top fluted roller 3, corresponding to the delivery tangent 27 which is identical with the tangent of arrival of the nip pressure belt 19 on the looping roller 18.

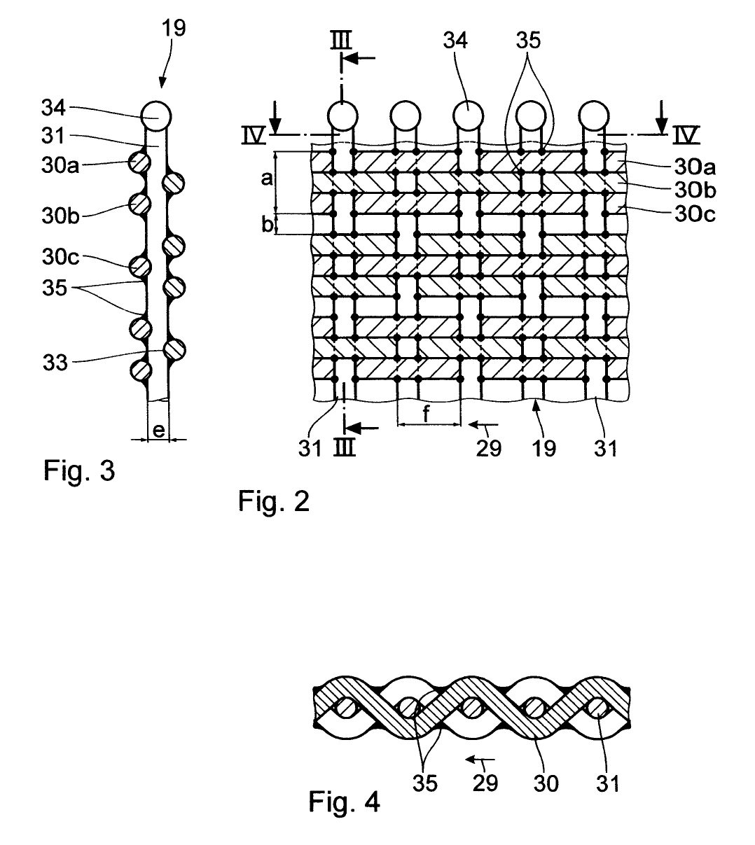

The nip pressure belt 19 is configured as a finely meshed belt of tensile strength, namely in the form of a fabric as seen in detail in FIGS. 2 to 5. It is comprised of warp threads 30 which extend in its longitudinal direction 29 that corresponds to the arrow 26, and of transverse weft threads 31. The warp threads 30 are configured in pairs of three individual warp threads 30a, 30b, 30c, these pairs of warp threads 30a, 30b, 30c having a width a that exceeds the distance b of neighbouring pairs of warp threads. The two outer warp threads 30a, 30c of each pair of warp threads extend equidirectionally i.e., they pass each over the same side of a weft thread 31, whereas the warp thread 30b in the middle is led oppositely, as seen in particular in FIGS. 2 to 4. With the three warp threads 30a, 30b, 30c per pair of warp threads 30a, 30b, 30c being provided and led in that way, symmetric placement of the respective weft thread 31 is attained.

That extension of the warp threads 30a to 30c alternates from one pair of warp threads 30a to 30c to the other, as seen in particular in FIGS. 2 and 3. That means that—related to the plan view of FIG. 2—whenever the middle warp thread 30b of FIG. 2 passes over a weft thread 31, the middle warp thread 30b of the neighbouring pair of warp threads 30a, 30b, 30c—again related to the plan view of FIG. 2—passes below the weft thread 31. The same applies reversely to the two outer warp threads 30a and 30c of equal extension of each pair of warp threads.

As visible in FIG. 5, each warp thread 30a to 30c is comprised of six strands 32 which are stranded and consequently intertwisted. The diameter c of each strand 32 is in the range of 0.2 mm. The diameter c of the strands 32 may also be less than 0.2 mm for reduction of wear, namely in the range of 0.15 to 0.2 mm. As a result, the diameter d of each warp thread 30a to 30c is in the range of 0.6 mm. The strands 32 are made of steel wire. Being stranded, the individual warp threads 30a to 30c are highly resistant to tensile strength on the one hand and very pliable on the other. As for the relation of the distance b of the pairs of warp threads 30a to 30c to the diameter d of the individual warp threads 30a, 30b, 30c, 1.2d≧a≧0.3 d applies.

The weft threads 31 consist of a material that is softer than the material the warp threads 30a to 30c are made of so that the warp threads 30a to 30c sort of dig into the weft threads 31, forming slight notches 33 therein. The free ends 34 of the weft threads 31 are spherical i.e., they are rounded for any risk of injury to be precluded.

The weft threads 31 are rod-type wires, the diameter e of which being in the range of 1.0 mm. The distance f of adjoining weft threads 31 is in the range of 1.0 to 1.5 mm, preferably in the range of 1.1 to 1.2 mm.

The nip pressure belt 19 is an open-ended metal fabric belt, the ends of which, in the vicinity of a weft thread 31, being conventionally assembled by a prior art soldered or welded-lug plug-in connection.

As seen in FIGS. 2 to 4, the warp threads 30 and the weft threads 31 are connected to each other where they intersect by means of suitable plastic material, each junction 35 being blackened in FIGS. 2 to 4. This kind of connection strongly augments the dimensional stability of the nip pressure belt 19 i.e., any slippage of the warp threads 30 in relation to the weft threads 31 in the longitudinal direction thereof is no longer possible, which also precludes any distortion or constrictions of the nip pressure belt 19. Producing the connection only at the intersections or junctions 35 at the places of intersections takes place in such a way that the nip pressure belt 19 dips into some suitable liquid plastic material which drips off after removal from the plastic bath so that plastics remain only at the junctions 35 where it bonds and cures.

The mode of operation of the machine is as follows:

A paper web 36 enters the area 10 of contact between the bottom and top fluted roller 2, 3, being corrugated by the flutings 8, 9. Glue is spread on the tips 38 of a respective corrugation 37 in the gluing device 13. No glue is spread on the remaining areas of the corrugated paper web 36. The deflection roller 17 supplies a liner web 39, also consisting of paper and having the same width as the web of paper 36. The liner web 39 is led in, bearing against the outer surface 40 of the nip pressure belt 19, and, in the nip pressure area 41 of the nip pressure belt 19 that is defined by the angle of belt contact g, it is pressed against, and connected to, the tips 38 of the corrugated paper web 36 that adheres to the fluting 9 of the top fluted roller 3. The nip pressure belt 19, by its outer surface 40, forces the liner web 39 against the corrugated paper web 36.

With the top fluted roller 3 being conventionally heated to, for example, approximately 170° C., the water contained in the glue 42 on the tips 38 of the corrugation 37 evaporates and escapes at least partially through the liner web 39 and the mesh-type nip pressure belt 19.

The finished glued web of corrugated board 43, single-faced with a liner web 39, runs off the top fluted roller 3 together with the nip pressure belt 19 in the direction of the delivery tangent 27 and, together with the nip pressure belt 19, is partially led around the looping roller 18. From there it is fed to a reel winder in a direction of discharge 44.

Heating the paper webs 36, 39 need not necessarily take place via the fluted roller 3. Alternatively or facultatively it may be effected by a heater 45 that is disposed within the range of the nip pressure belt 19 between the deflection roller 17 and looping roller 18, which is roughly outlined by dashed lines in FIG. 1.

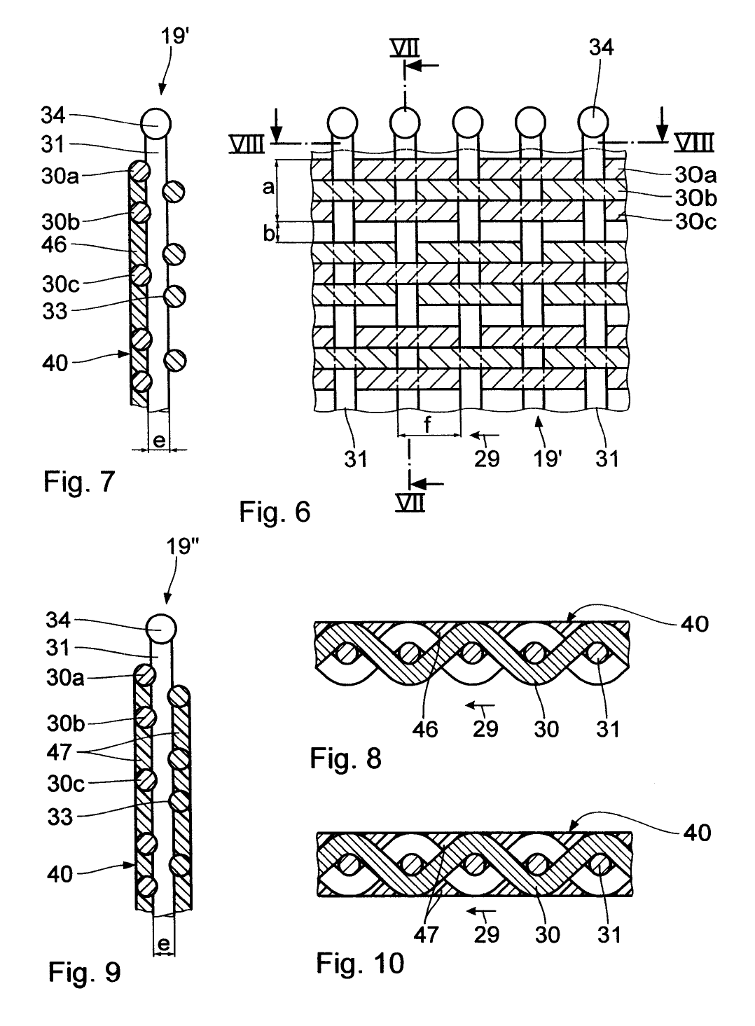

As can be taken from FIGS. 6, 7 and 8, the dimensional stability of the nip pressure belt 19′ can also be obtained by it being provided, on one side of the weft threads 31, with a coating 46 of suitable plastic material. That coating 46, which substantially envelops the warp threads 30 on the corresponding side, is applied to the outer surface 40 so that this side will bear against the paper web 36. That kind of a coating 46 precludes the permeability to vapour of the nip pressure belt 19′; however, it is dirt-repelling i.e., fibers and the like from the paper web 36 cannot soil the nip pressure belt 19′ any longer.

As seen in FIGS. 9 and 10, it is also possible to apply to the nip pressure belt 19″ a coating 47 which completely covers the fabric of warp threads 30 and weft threads 31 to both sides.

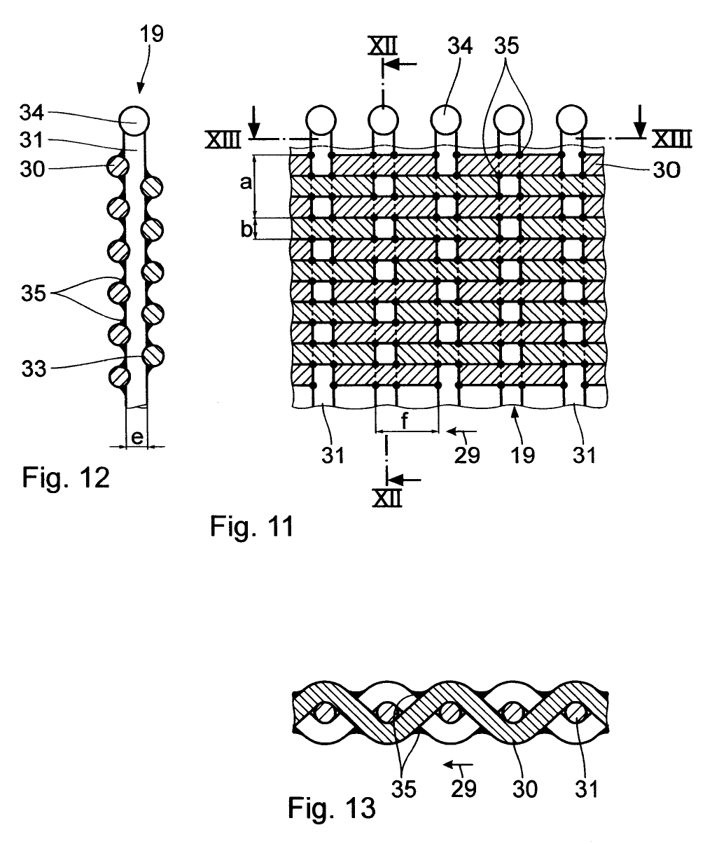

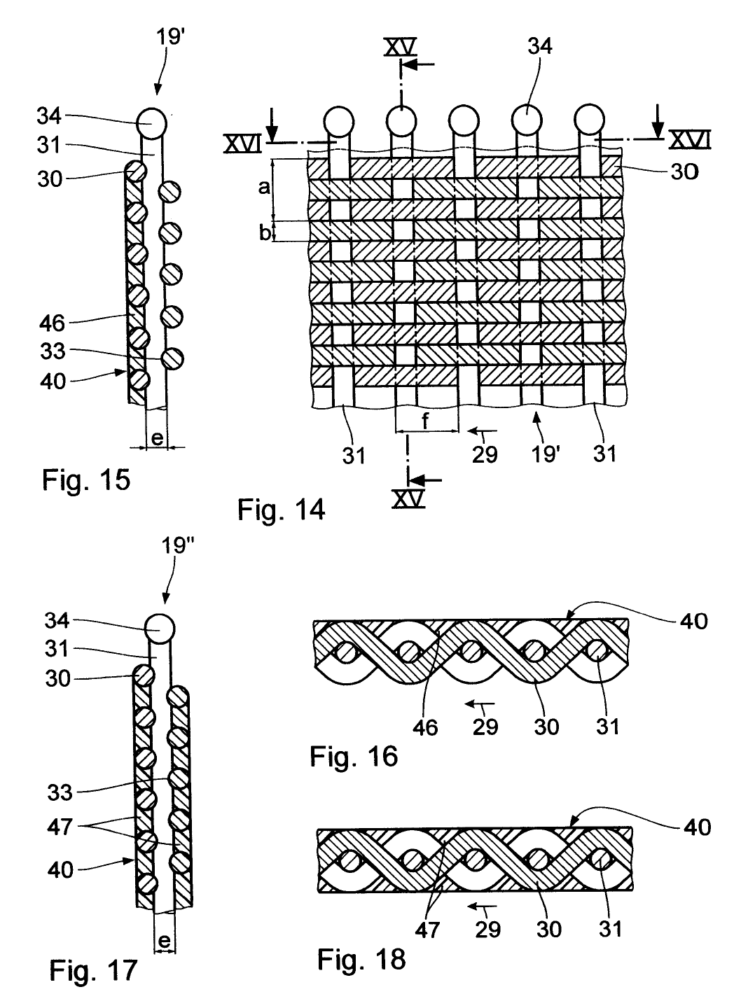

In lieu of the three-warp-thread design of the nip pressure belt 19, 19′, 19″ illustrated in FIGS. 2 to 10, the fabric itself can also be of tight configuration i.e., having closely adjoining warp threads 30. The kind of coating is the same of described above. The illustration of FIGS. 11, 12, 13 corresponds to that of FIGS. 2 to 4; the illustration of FIGS. 14, 15, 16 corresponds to the illustration of FIGS. 6 to 8; the illustration of FIGS. 17, 18 corresponds to that of FIGS. 9, 10.

Plastic materials considered suitable for the coatings 46 or 47 are PU (polyurethane) in the form of an elastomeric 2-component adhesive. Furthermore, materials similar to PTFE are conceivable i.e., polytetrafluorethylene in elastomeric modification. Furthermore, any plastic materials are conceivable that possess sufficient resistance to temperature and abrasion.

The unilateral coating 46 may further be produced by doctoring i.e., by the plastic material being applied in liquid form by an applicator roller, on which the liquid plastic material is given a preset layer thickness by means of a doctor. The unilateral coating 46 and the bilateral coating 47 may also be put into practice by films being pressed on. Finally, the plastic material can also be spread in the form of a paste with cross-linkage taking place by heating in a furnace.

What is claimed is:

1. A machine for the manufacture of a web of at least single-faced corrugated board (43), comprising
two fluted rollers (2, 3) for producing a corrugation (37) on a paper web (36);
a gluing device (13) for glue (42) to be spread on the tips (38) of the corrugation (37) of the corrugated paper web (36);
a nip pressure device (16) for a liner web (39) to be pressed against the tips (38), provided with glue (42), of the corrugated paper web (36) that rests on one of the fluted rollers (3) along a nip pressure area (41);
the nip pressure device (16) comprising a continuous nip pressure belt (19, 19′, 19″), which is led along of deflection roller (17) and another roller (18), and which is forced against the fluted roller (3) along the nip pressure area (41), and which is comprised of a fabric of metal with warp threads (30a, 30b, 30c) and weft threads (31);
wherein the warp threads (30) and the weft threads (31), at least where intersecting, are connected to each other by plastic material.

2. A machine according to claim 1, wherein the warp threads (30) and the weft threads (31) are connected to each other only where they intersect.

3. A machine according to claim 1, wherein the warp threads (30) and the weft threads (31), by a coating (46), are connected to each other over their full surface at least on one side of the nip pressure belt (19′).

4. A machine according to claim 3, wherein the coating (46) is located on an outer surface (40), resting on the liner web (39), of the nip pressure belt (19′).

5. A machine according to claim 1, wherein the nip pressure belt (19″) is provided with a coating (47) that is disposed on both sides of the weft threads (31).

6. A machine according to claim 1, wherein the warp threads (30a, 30b, 30c) are provided in pairs of three warp threads (30a, 30b, 30c);
wherein two neighbouring pairs of warp threads (30a, 30b, 30c) have a distance b;
wherein each pair of warp threads (30a, 30b, 30c) has a width a; and
wherein the distance b of two neighbouring pairs of warp threads (30a, 30b, 30c) is less than the width a of each pair of warp threads (30a, 30b, 30c).

7. A machine according to claim 1, wherein the warp threads (30) lie close to each other.
